(19) United States
(12) Patent Application Publication
(10) Pub. No.: US 2019/0145131 A1
(43) Pub. Date: May 16, 2019

(54) Electronic Coded Lock

(71) Applicant: ZhiYong Ding, Suzhou New District, Jiangsu Province (CN)

(72) Inventor: ZhiYong Ding, Suzhou New District, Jiangsu Province (CN)

(21) Appl. No.: 15/430,011

(22) PCT Filed: Feb. 9, 2016
(86) PCT No.: PCT/CN2016/100773

§ 371 Date: Feb. 10, 2017

(30) Foreign Application Priority Data
Jul. 28, 2016 (CN) 201610626189.4

(51) Int. Cl. E05B 49/00; E05B 47/00

(52) U.S. Cl. CPC E05B 49/004; E05B 47/0001

(57) ABSTRACT

This invention discloses a kind of electronic cipher lock including the body of electronic cipher lock (1) with a password input keyboard (11) and an emergency mechanical keyhole (12) installed in the body of electronic cipher lock (1) as its characteristics. The electronic cipher lock of this structure adopts two ways—electronic cipher and key—and make it into reality that electronic cipher lock can be open and closed simultaneously by these two ways. This kind of electronic cipher lock is safe and reliable, sturdy and durable and has a novel structure.

### TECHNICAL FIELD

This invention is involved in communication equipment field and specially concerned with a kind of electronic cipher lock of communication cabinet.

### BACKGROUND TECHNOLOGY

With the process of society and technology, communication cabinet has gradually played an increasingly important role in people's life and industrial life. Currently, communication cabinet usually adopts common mechanical lock for safety and prevention. But the security is low and the key is easy to lost, which go against security and anti-theft.

### Details of Inventions

The technical issues to be solved by this invention is to provide a kind of electronic cipher lock that is safe and reliable, convenient to use, sturdy and durable, and with a beautiful appearance.

To solve the problems of current technology, this invention provides the technical solutions as below:

A kind of electronic cipher lock containing the body of electronic cipher lock has a password keyboard and an emergency mechanical keyhole installed in the body as its characteristics.

For optimization, a temperature and humidity display device is installed in the body of electronic cipher lock.

For optimization, the material of the body of electronic cipher lock is stainless steel.

Compared with the solutions of existing technology, the advantages of this invention are:

1. For the technical solutions provided by this invention, the lock of communication cabinet can be open in two ways—through electronic cipher and key. The structure is novel, and the solution is safe and reliable.

2. For the technical solutions provided by this invention, the material of the body of electronic cipher lock is stainless steel, which is sturdy and durable, has wear and impact resistance and a long service life.

### DESCRIPTION OF FIGURES

The following figures and implementation examples are for further description of this invention:

FIG. 1: implementation example of this invention, a schematic diagram of the structure of an electronic cipher lock;

FIG. 2: implementation example of this invention, a front view of an electronic cipher lock;

FIG. 3: implementation example of this invention, a left view of an electronic cipher lock;

Among: 1—body of electronic cipher lock, 11—passport input keyboard, 12—emergency mechanical keyhole, 13—temperature and humidity display device.

### SPECIFIC IMPLEMENTATION METHOD

The following specific implementation examples are the further explanation to the solutions mentioned above. It is understood that these implementation examples are used to explain this invention but not limited to confine the scope of this invention. The implementation conditions adopted in the examples can be adjusted further according to the specific manufacturer. Unspecified implementation condition is usually the same as the condition in ordinary experiment.

### Implementation Examples

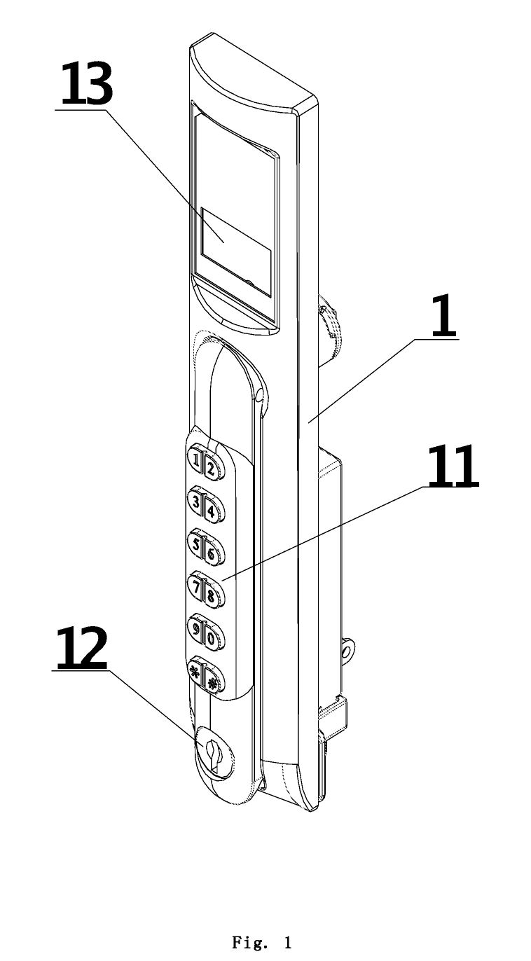

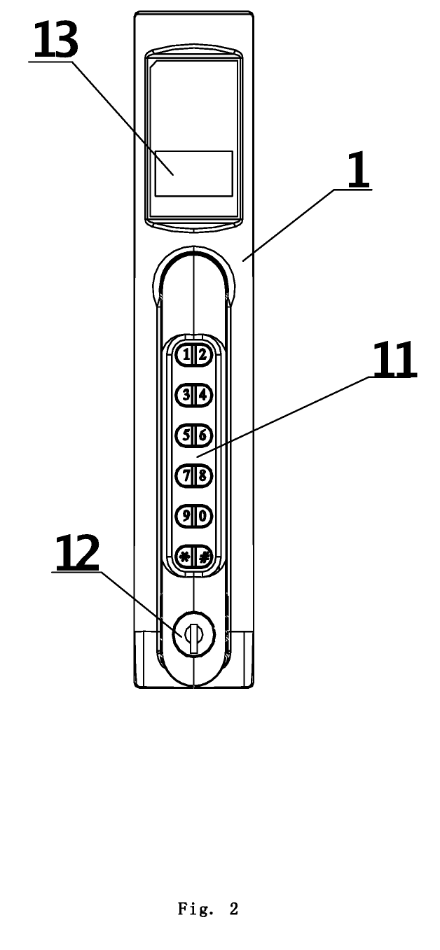

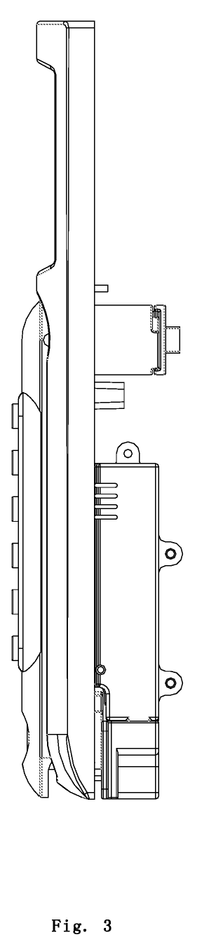

As illustrated in FIGS. 1 to 3, it is a kind of electronic cipher lock containing the body of electronic cipher lock 1. And there are password input keyboard 11 and emergency mechanical keyhole 12 installed in the mentioned body of electronic cipher lock 1. The password input keyboard 11 is a number keypad used for setting and input passwords. The emergency mechanical keyhole 12 is used for mechanical key to open when the electronic system was broken or collapsed. It is safe and reliable with double assurance.

A temperature and humidity display device 13 is installed in the body of electronic cipher lock 1.

The material of the body of electronic cipher lock 1 is stainless steel.

The implementation examples are only for introducing the technical conception and characteristics of this invention. The purpose is to make people who are familiar with this technology can understand the content of this invention and make it into implementation, but not to confine the protection scope of this invention. Any equivalent transformation or modification based on the spiritual essence of this invention shall be covered by the protection scope of this invention.

What is claimed is:

1. A kind of electronic cipher lock containing the body of electronic cipher lock (1) has a password input keyboard (11) and an emergency mechanical keyhole (12) on the body (1) as its characteristics.

2. As to the electronic cipher lock described in claim 1, its characteristic is that a temperature and humidity display device (13) is installed in the body (1).

3. As to the electronic cipher lock described in claim 1, its characteristic is that the material of the body (1) is stainless steel.
